(19) United States
(12) Patent Application Publication
(10) Pub. No.: US 2006/0212804 A1
(43) Pub. Date: Sep. 21, 2006

(54) Method and system for formatting web pages having constrained dynamic regions on content templates

(75) Inventors: Anthony L. Jackson, Seattle, WA (US); Shiu-Kai Lee, Bellevue, WA (US); William J. Griffin, Sammamish, WA (US)

Correspondence Address: MERCHANT & GOULD PC, P.O. BOX 2903, MINNEAPOLIS, MN, 55402-0903, US

(73) Assignee: Microsoft Corporation, Redmond, WA (US)

(21) Appl. No.: 11/083,134

(22) Filed: Mar. 15, 2005

(51) Int. Cl. G06F 17/00

(52) U.S. Cl. 715/520; 715/530; 715/517

(57) ABSTRACT

The present invention generally relates to methods, systems, and data structures for creating web pages. In embodiments of the present invention, a web page template is created. One or more instructions are received to construct a web page template with a zone. A constraint is assigned to the zone that prohibits actions within the zone at a web authoring. During web authoring, a web author modifies the content within the zone but is prohibited from any action that violates a constraint assigned to the zone.

### TECHNICAL FIELD

The present invention relates generally to content creation for the a computer network. More particularly, the present invention relates to the formatting of components within web pages.

### BACKGROUND OF THE INVENTION

Computer networks, such as the Internet, have become an important source of information for people around the world. As such, many organizations, businesses, and individuals have created web sites for computer networks. Generally, a web site is a compilation of one or more web pages that a person can access and view with a web browser or web browsing software. The information presented on the web pages can be diverse and expansive. Unfortunately, the complexity in creating and managing the web sites becomes increasingly difficult as the amount of information presented in the web pages grows in volume and diversity.

In creating web sites, organizations generally split the web page creation process into steps to allow for division of labor and specialization. Generally, the process of creating a web page has two steps, a web page template creation step and a web authoring step. Some software applications or tools for creating web sites, such as Microsoft® FrontPage® web site creation and management application, allow a first person or group to create the web page template. A web page template is a web page that allows modification of some or all of the content within the web page. After the web page template is created, another group or person can place web parts, which are components within a web page that provide or receive information, within the web page using the same software application or possibly a web browser, such as Microsoft® Internet Explorer web browser. By splitting the web page creation process into two steps, one group, such as an information technology department in a corporation, can create and manage the overall web site while a second group, such as a marketing department in a corporation, can populate the web site with certain information.

Unfortunately, the division of labor has some problems. The control over the information allowed on the web site is relinquished to the groups that place the information onto the web site. The relinquishment of control generally creates a more chaotic and mistake prone web authoring process. There can be numerous people all placing different forms of information onto the website. In some cases, confidential information may be posted onto the web site. A robust review process can eliminate this problem, where every posting to the web site is reviewed and authorized. However, such a review process is manpower intensive and requires a great deal of oversight, which increases the cost of managing the web site. In addition, a review process decreases the flexibility provided by the web site creation tools and provided by splitting the web page creation process into two steps. It is with respect to these and other considerations that the present invention has been made.

### SUMMARY OF THE INVENTION

The present invention generally relates to the creation of web pages. In embodiments of the present invention, a web page template is created. One or more instructions are received to construct a web page template. An instruction to create a zone within the web page template is then received. A zone, in embodiments, is a dynamic web page region that allows a web author to add or manipulate content within the zone. A constraint is then received that is assigned to the zone and prohibits actions within the zone during web authoring. Finally, a constrained web page template is generated having a zone with a constraint.

In another embodiment, a method for authoring a web page from a constrained web page template comprises providing a web page template having a zone, wherein the zone has an assigned constraint. Then, a web authoring action, in the zone that would violate the assigned constraint, is prohibited.

In still another embodiment, the data structure for the constrained web page template comprises a first data field that contains configuration information about a web page template, a second data field that contains configuration information for a zone embedded within the web page template, and a third data field that contains a constraint that prohibits a possible configuration of the zone.

The invention may be implemented as a computer process, a computing system, or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the present invention and its improvements can be obtained by reference to the accompanying drawings, which are briefly summarized below, to the following detailed description of exemplary embodiments of the invention, and to the appended claims.

### BRIEF DESCRIPTION OF THE DRAWINGS

FIG. 1 is an exemplary embodiment of a web page having being created from a web page template having at least one zone where at least one of the zones has an assigned constraint according to the present invention.

FIG. 2 is a functional diagram illustrating a computing environment and a basic computing device that operates the web page template creation system or the web authoring system according to the present invention.

FIG. 3 is a functional diagram of a system for creating a web page template for a web page that has one or more zones and one or more of the zones contains a constraint according to the present invention.

FIG. 4 is a functional diagram of a system for authoring a web page using a web page template that has one or more zones and one or more of the zones contain a constraint that prohibit certain actions during the authoring of the web page according to the present invention.

FIG. 5 is an exemplary data structure for a web page template having a first data field defining the web page template, a second data field defining a zone, and a third data field containing one or more constraints that prohibit certain actions during web authoring according to the present invention.

FIG. 6 is a flow diagram representing an embodiment of the present invention for creating a web page from a web page template where an action is prohibited during the web authoring process because of an assigned constraint.

FIG. 7 is a flow diagram representing an embodiment of the present invention for creating a web page template with one or more zones that contain a constraint.

FIG. 8 is a flow diagram representing an embodiment of the present invention for prohibiting an action during web authoring according to a constraint assigned to a zone in a web page template.

### DETAILED DESCRIPTION OF THE INVENTION

The present invention will now be described more fully hereinafter with reference to the accompanying drawings, in which embodiments of the invention are shown. The invention may however, be embodied in many different forms and should not be construed as limited to the embodiments set forth herein. Rather, these embodiments are provided so that the disclosure will be thorough and complete and will fully convey the scope of the invention to those skilled in the art.

The present invention relates to embodiments of methods and systems that prohibit actions during a web page creation process. In embodiments of the present invention, the web page creation process has two phases: a web page template creation phase and a web authoring phase. A web page template is created during a web page template creation phase, and the web page template has at least one zone. A zone is an area within the web page template that allows dynamic editing within the zone during the web authoring phase. In one embodiment, the zone allows the inclusion, deletion, arrangement, or modification of web parts within the zone. A web part is a control that provides or receives information from a user of the web page. In embodiments of the present invention, one or more constraints are assigned to at least one of the zones. The constraints prohibit certain editing actions in the zone, including the changes to web parts mentioned above, during web authoring.

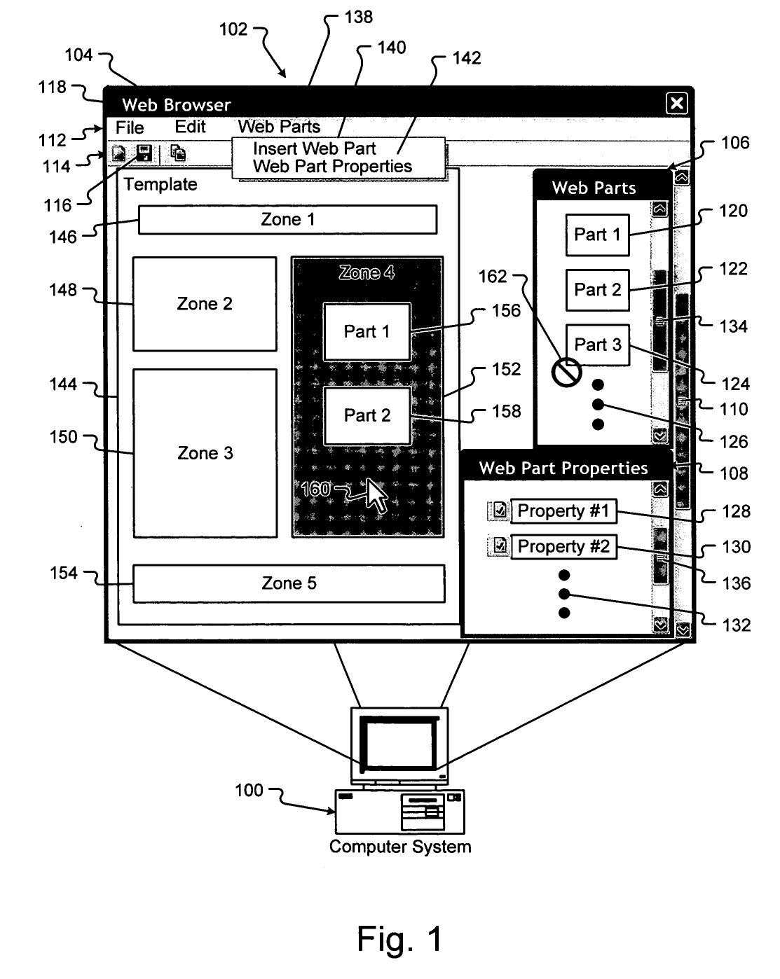

A computer system 100 that may be used to create a web page using a web page template having one or more zones with constraints in accordance with the present invention is shown in FIG. 1. As used herein, a “computer system” shall be construed broadly and is defined as one or more devices or machines that execute programs for displaying and manipulating text, graphics, symbols, audio, video, and/or numbers.

The computer system 100 displays information, such as display screen 102. The display screen 102 is enlarged to show details of the display. The display 102 relates to an over-simplified display of an example web browser application with the capability of creating a web page using a web page template. Importantly, although display 102 displays a web browser, many other types of software application may be used to both generate the web page template and create the web page from the web page template in accordance with the present invention and thus, the web browser example is not meant as a limitation, but merely as an illustration.

In this particular example, the display 102 has a web browser window 104 with a title bar 118. Web browser window 104 has a menu bar 112 and a tool bar 114. Tool bar 114 provides user controls such as a save control 116, among potentially many others. Such user interface controls are generally known in the art and are useful in managing certain types of information.

Within web browser window 104, there are two sub-windows, such as a web parts window 106 and a web part properties window 108. There may be other windows for managing other information as indicated by scroll bar 110. In this particular example, web parts window 106 displays a set of web parts 120, 122, and/or 124 that may be available to include in a web page. More web parts may be available to include in a web page as represented by the ellipses 126 and scroll bar 134. Web part properties window 108 displays a set of web part properties 128 and/or 130 that may be set for a web part in the web page. More web part properties may be available to set for web parts in a web page as represented by the ellipses 132 and the scroll bar 136. In embodiments of the present invention, the web parts window is generated when a web parts menu 138 is selected in the menu bar 112 and a drop down menu for “insert web parts” 140 is selected. In embodiments of the present invention, the web part properties window is generated when a web parts menu 138 is selected in the menu bar 112 and a drop down menu for “web part properties” 142 is selected. In other embodiments, some other user interface selection, such as a toolbar button, generates the web parts window 106 or the web part properties window 108.

In embodiments of the present invention, the web browser window 104 displays a web page template 144 used to create a web page. In embodiments of the present invention, a web page template 144 is created that defines the basic formatting, structure, and content of a web page in a web site. The web page template 144 forms the underlying structure for what will become a web page published to a network, such as an internet or an intranet. The web page template 144 allows further editing or modifying of the web page by web authors by establishing portions of the web page template 144 that are static and other portions of the web page template 144 that are dynamic. The dynamic portions of the web page template 144 allow a web author to add, change, or delete components in those dynamic portions of the web page template 144.

In one embodiment, the web page template 144 has one or more zones 148, 150, 152, 154, and 146. Each zone can contain different content and/or formatting. For example, an introductory header may appear in Zone 1 146, while Zone 2 148 may contain a short description of the information provided on the web page. In embodiments of the present invention, the zones 152 and/or 154 are the dynamic portions of the web page template 144 that allow web authors to modify the content within those zones 152 and/or 154. In embodiments of the present invention, the zones 152 and/or 154 accept the inclusion of web parts 156 and/or 158. A web part 156 and/or 158 is any component in a web page that can provide information or receive input from a user of the web page.

The zones 152 and/or 154, in embodiments of the present invention, have definitions stored with the web page template 144 for the zone 152 and/or 154. The definitions provide the configuration information that set the appearance and structure of the zones 152 and/or 154. In embodiments, one or more of the definitions is a constraint. A constraint is an instruction for a particular zone 152 and/or 154 that prohibits or restricts the web author's ability to include, delete, or modify web parts 156 and/or 158 within that zone 152 and/or 154. Assigning constraints to a particular zone 152 and/or 154 provides a web author some flexibility in developing content within a web page but also prohibits actions by those web authors that could have deleterious affects. For example, the web author may use cursor 1 160, at a first time, to select zone 4 152. At a later time, the web author may try to insert web part 3 124 from the web parts window 152. However, there may be a constraint on zone 4 152 that does not allow the inclusion of web part 3 124 into that zone. As such the cursor 162 will change appearance to inform the web author that the insertion of web part 3 124 into zone 4 152 is constrained and not allowed. Further description and further embodiments of web page template 144 having zones 152 and/or 154 with one or more constraints is provided hereinafter.

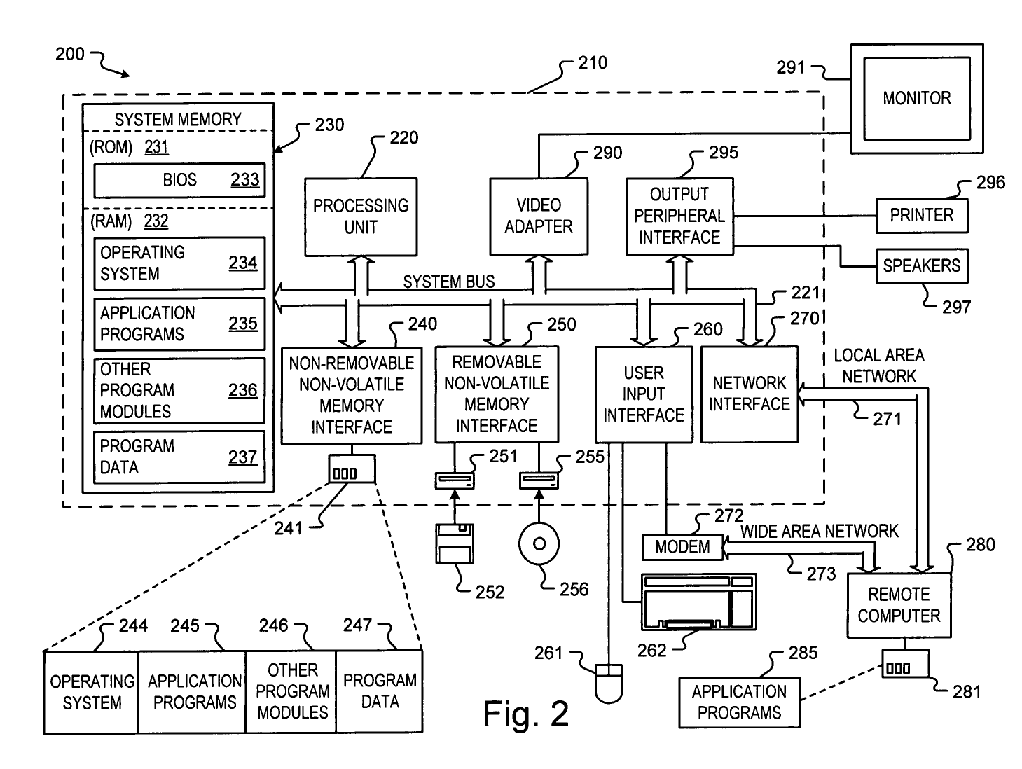

An example of a suitable computing system environment 200 on which the invention may be implemented is illustrated in FIG. 2. The computing system environment 200 is only one example of a suitable computing environment and is not intended to suggest any limitation as to the scope of use or functionality of the invention. Neither should the computing environment 200 be interpreted as having any dependency or requirement relating to any one or combination of components illustrated in the exemplary operating environment 200.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary computer system 200 for implementing the invention includes a general purpose-computing device in the form of a computer 210. Components of the computer 210 may include, but are not limited to, a processing unit 220, a system memory 230, and a system bus 221 that couples various system components including the system memory 230 to the processing unit 220. The system bus 221 may be any of several types of bus structures including a memory bus or memory controller, a peripheral bus, or a local bus using any of a variety of bus architectures. By way of example, and not limitation, such architectures include the Industry Standard Architecture (ISA) bus, the Micro Channel Architecture (MCA) bus, the Enhanced ISA (EISA) bus, the Video Electronics Standards Association (VESA) local bus, and the Peripheral Component Interconnect (PCI) bus, also known as the Mezzanine bus.

Computer 210 typically includes a variety of computer readable media. Computer readable media can be any available media that can be accessed by the computer 210 and includes both volatile and nonvolatile media and removable and non-removable media. By way of example, and not limitation, computer readable media may comprise computer storage media and communication media. Computer storage media includes volatile, nonvolatile, removable, and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 210. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of the any of the above should also be included within the scope of computer readable media.

The system memory 230 includes computer storage media in the form of volatile and/or nonvolatile memory, such as read only memory (ROM) 231 and random access memory (RAM) 232. A basic input/output system 233 (BIOS), containing the basic routines that help to transfer information between elements within computer 210, such as during start-up, is typically stored in ROM 231. RAM 232 typically contains data and/or program modules that are immediately accessible to and/or presently being operated on by processing unit 220. By way of example, and not limitation, FIG. 2 illustrates operating system 234, application programs 235, other program modules 236, and program data 237; a web page created from a web page template, such as web page template 144, would be stored as program data and displayed from RAM 232.

The computer 210 may also include other removable/non-removable, volatile/nonvolatile computer storage media. By way of example only, FIG. 2 illustrates a computer 210 with a non-removable, non-volatile memory interface 240 that reads from or writes to non-removable, nonvolatile magnetic media 241, such as a hard drive. Computer 210 may also include a non-volatile memory interface 250 that reads from or writes to a device 251, such as a disk drive, that reads from or writes to a removable, non-volatile media 252, such as a magnetic disk. In addition, the computer 210 may include an optical disk drive 255 that reads from or writes to a removable, nonvolatile optical disk 256, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 241 is typically connected to the system bus 221 through a non-removable memory interface, such as interface 240, and magnetic disk drive 251 and optical disk drive 255 are typically connected to the system bus 221 by a removable memory interface, such as interface 250.

The drives and their associated computer storage media discussed above and illustrated in FIG. 2, provide storage of computer readable instructions, data structures, program modules, and other data for the computer 210. For example, hard disk drive 241 is illustrated as storing operating system 244, application programs 245, other program modules 246, and program data 247, which can either be the same as or different from operating system 234, application programs 235, other program modules 236, and program data 237. Operating system 244, application programs 245, other program modules 246, and program data 247 are given different numbers here to illustrate that, at a minimum, they are different copies. A user may enter commands and information into the computer 210 through a user input interface 260 connected to user input devices, such as a keyboard 262 and pointing device 261, commonly referred to as a mouse, trackball, or touch pad. Other input devices (not shown) may include a microphone, joystick, game pad, satellite dish, scanner, or the like. These and other input devices are often connected to the processing unit 220 through a user input interface 260 that is coupled to the system bus 221, but may be connected by other interfaces and bus structures, such as a parallel port, game port, or a universal serial bus (USB).

A monitor 291 or other type of display device is also connected to the system bus 221 via an interface, such as a video interface 290. In addition to the monitor 291, the computer 210 may also include other peripheral output devices such as speakers 297 and printer 296, which may be connected through an output peripheral interface 295.

The computer 210 may operate in a networked environment using logical connections to one or more remote computers, such as a remote computer 280. The remote computer 280 may be a personal computer, a server, a router, a network PC, a peer device, or other common network node, and typically includes many or all of the elements described above relative to the computer 210, although only a memory storage device 281 has been illustrated in FIG. 2. The logical connections depicted in FIG. 2 include a local area network (LAN) 271 and a wide area network (WAN) 273, but may also include other networks, such as wireless networks. Such networking environments are commonplace in offices, enterprise-wide computer networks, intranets, and the Internet.

When used in a LAN networking environment, the computer 210 is connected to the LAN 271 through a network interface or adapter 270. When used in a WAN networking environment, the computer 210 typically includes a modem 272 or other means for establishing communications over the WAN 273, such as the Internet. The modem 272, which may be internal or external, may be connected to the system bus 221 via the user input interface 260, or other appropriate mechanism. In a networked environment, program modules depicted relative to the computer 210, or portions thereof, may be stored in the remote memory storage device 281. By way of example, and not limitation, the remote application programs 285 reside on memory device 281. It will be appreciated that the network connections shown are exemplary and other means of establishing a communications link between the computers may be used.

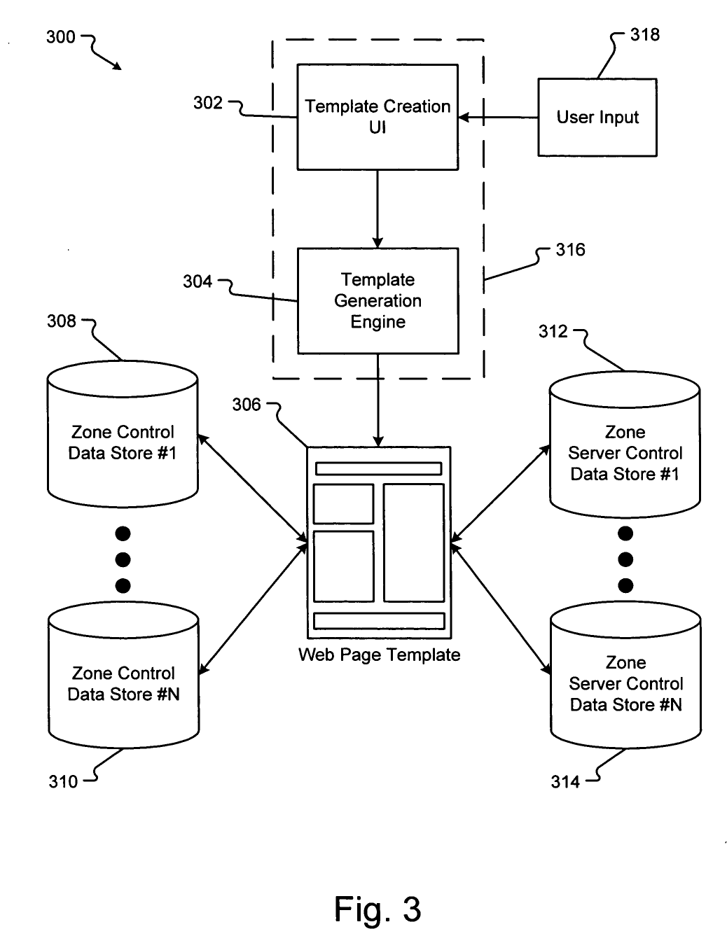

An embodiment of a web page template creation system 300 operable to construct a web page template, such as web page template 144, including one or more zones, such as zones 152 and/or 154, with one or more constraints is shown in FIG. 3. A web page template developer enters web page template input 318 into a web page template creation user interface (UI) 302 of a template creation system 316. The input 318 from the UI 302 is sent to a web page template generation engine 304, which creates the web page template 306. In one embodiment, the developer writes the code, such as by writing HTML, XML, or other type code. In another embodiment, the developer uses the UI 302 of a web page development application 316, such as Visual Studio.Net development system or Microsoft FrontPage® web page creation application both of which are available from Microsoft® Corporation of Redmond, Wash.

In a further embodiment, the developer uses a web creation application that is an Active Server Pages application, such as ASP.NET web creation application distributed by Microsoft® Corporation of Redmond, Wash., to create more dynamic content within the web page. In this embodiment, the web page template 306 may be a web page template file with an “.aspx” extension. Hereinafter, the zones will be described as portions created with ASP, but the present invention is not limited to this particular embodiment. Rather, any development platform capable of creating zones with constraints is suitable in the present invention.

The definitions for the different components in the web page template 306 become part of the code that creates and configures the web page. In embodiments of the present invention, every part or portion of the template 306 has a section of code for that part, which is stored as part of the template 306. In one embodiment, the web page template 306 has one or more zones, such as zones 146, 148, and/or 150. The template developer can define a zone when creating the web page template 306. In one embodiment, zones have a “zone control” or a set of allowed actions that may occur within the zone during latter web page authoring. In embodiments of the present invention, in zones 146, 148, and/or 150, the zone control settings may allow any editing or may not allow any editing within the zones. Thus, zones 146, 148, and/or 150 do not allow the inclusion of constraints that can prohibit or allow a certain, discrete action, such as inserting a particular web part. In other embodiments, any zone within the web page template 306 includes constraints on one or more web authoring actions. Hereinafter, the present invention is described with particular attention to zones. It should be noted that some or all of the description of the zones that follows may apply to any type of zone, as one skilled in the art will appreciate. The zone control settings, in embodiments of the present invention, are saved in one or more zone control data stores 308 and/or 310. The zone control data stores 308 and/or 310 become part of the web page template code.

The zones, such as zones 152 and/or 154, are a particular type of the zone with a particular set of zone controls. In one embodiment, the zones are server controls. A server control is a server-side component that encapsulates a user interface and the related functionality. The server control can provide more dynamic content to the web page template 306. Thus, the zone server control has settings that provide different types of actions within the zone. As such, the zone server control settings are saved in one or more other data stores, such as zone server control data store #1 312 and zone server control data store #N 314. The zone server control data stores 312 and/or 314 are also saved with the web page template code.

In embodiments of the present invention, the zone settings contain constraints. A constraint is a limitation or prohibition on a discrete action that may occur during web authoring. The constraints are saved as settings for the zones with the zone sever control settings in the data stores 312 and/or 314. Constraints may take numerous forms and limit or prohibit many various discrete actions. In some embodiments, the constraints can limit the types of web parts that a web author can place in a zone, can limit the types of manipulations or modifications to the web parts already part of a zone, can limit the number of web parts allowed in a zone, can prohibit certain types of arrangements of the web parts within the zone, or can limit the property configurations allowed for types of web parts within the zones. One skilled in the art will recognize other types of constraints that may be applied to the zones and that the present invention is not limited to the specific embodiments of constraints described herein.

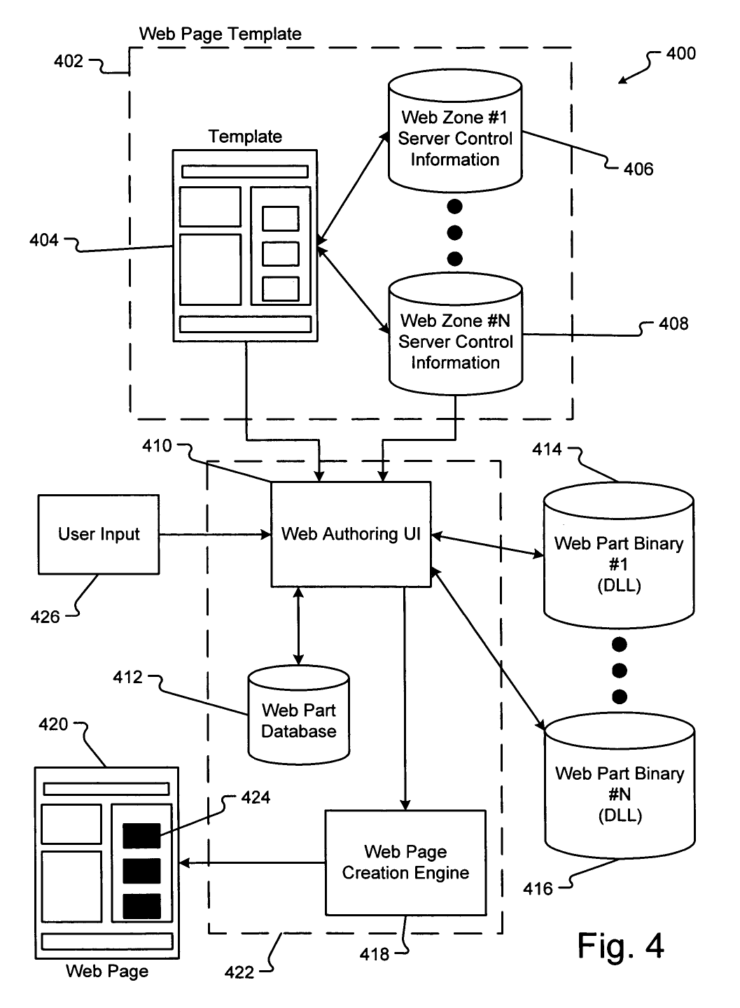

A web authoring system 400 operable to employ a web page template 402 in creating a web page 420 that includes one or more web parts 424 placed into one or more zones having certain constraints is shown in FIG. 4. In embodiments of the present invention, a web author uses a web page authoring application 422, which may be a web browser such as Microsoft® Internet Explorer web browser, to create a web page 420 having web parts 424. In embodiments, the web page authoring application 422 comprises a web page creation engine 418 and a web authoring UI 410 that receives web authoring input 426. A web page author requests a web page template 402, such as by entering a Uniform Resource Locator (URL) into the web browser 422 to load web page content. The web page template 402 is provided to the web author in the web page authoring application 422. In one embodiment, the web page template 402 is provided from a server or remote computer. A web page template 402, in embodiments, comprises the template 404 with the one or more web zone server control information data stores, such as web zone #1 server control information 406 and/or web zone #N server control information 408, embedded within the web page template code. The web zone server control information contains the constraints to actions allowed in any zone within the template 404.

The web page author modifies or adds content to the web page template 402 to create the web page 420. In embodiments, the web page author adds or modifies web parts, such as web parts 156 and/or 158, in one or more zones. To add web parts, the web author inserts a pointer to a web part into a web part database 412. The web part database 412 comprises a listing of web parts within a web page 420 and the configuration of the web parts. In some embodiments, the web part database 412 comprises a web part identification (ID), a zone ID, such as zone 4 152, a pointer to the web part binary, or other information.

The web part binary is the actual code that creates and configures the web part. In one embodiment, the web part binary is stored in a web part binary data store, such as web part binary data store #1 414 or web part data store #N 416. In one embodiment, the web part binary data store 414 and/or 416 is a dynamic link library (DLL) with pointers to binary within the computer storage. In one embodiment, the web page creation application 422 provides a web part binary data store 414 that comprises one or more standard web parts. In further embodiments, a third party provides one or more other web part binary data stores 416 that comprises the binary for one or more third party or user-specific web parts. The constraints within the web page template 402 can be applied similarly to third-party web parts and to standard web parts.

During web authoring, a web page creation application 422 loads a web page template 402 by reading the code for the template 404 and the settings for the zones, including the constraints included in the web zone server control information 406 and/or 408. In one embodiment, the constraints within the web zone server control information 406 and/or 408 restrict functions within the web authoring UI 410. For example, a web author may be able to add one type of web part but not a different type of web part. In another example, a web author may be able to edit only a portion of the web part properties. Web part properties are the set of information that defines the appearance, behavior, etc., of the web part.

The web authoring UI 410 provides the web author with UI responses if the action is not allowed. For example, the web authoring UI shows a circle with a line through it, e.g., “◯,” to alert the author that the action is prohibited. In another example, the UI 410 does not show a clickable feature (e.g., the cursor does not change to show a clickable interface) or provides an audible sound when the action is prohibited. One skilled in the art will recognize other ways a UI 410 can alert the web author that an action is constrained. In another embodiment, a web author attempts an action within the web authoring UI 410, the web page creation engine 416 checks the constraints in the web zone server control information 406 and/or 408, and if the action is not allowed, the web authoring UI reverses or never completes the action.

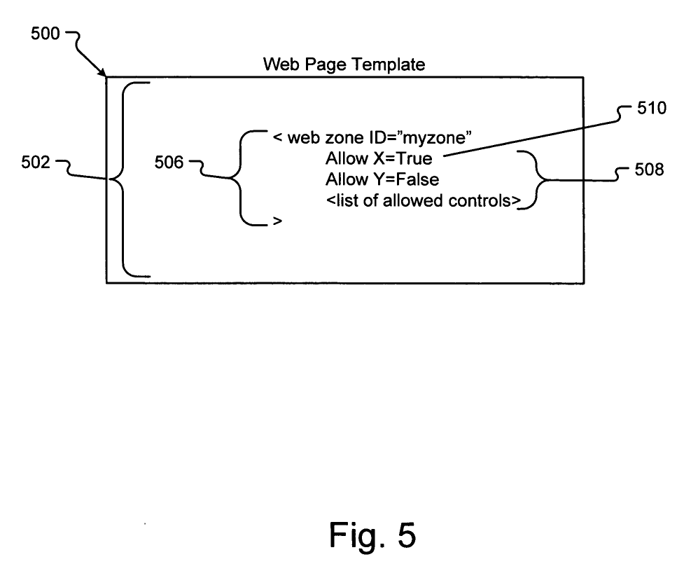

An exemplary embodiment of a web page template 500 that contains constraints is shown in FIG. 5. In embodiments of the present invention, the web page template 500 is written in a declarative language, such as XML, ASPX, or HTML. The web page template 500 has three data fields. The first data field represents the template data field 504, which defines the entire template and the corresponding web page. In embodiments of the present invention, the web page template data field 504 contains one or more zones, one or more items of content, one or more web components, or other information. In embodiments of the present invention, at least one of parts of the web page template data field 504 is the second data field 506, which defines a zone, such as zone 152. The zone data field 506 comprises all the definitions and configuration information for creating the zone within the web page templates. The definitions can include size, orientation, location, visual characteristics, or other such information.

In embodiments of the present invention, the zone data field 506 includes the third data field 508, which comprises the constraints assigned to and/or applied to the zone. The web zone constraint data field 508 comprises one or more constraints, such as constraint 510. The constraints define the actions either allowed or not allowed in the zone during web authoring. As explained above in conjunction with FIG. 3, the constraints can limit or prohibit the types of web parts that a web author can place in a zone, the types of manipulations or modifications to the web parts already part of a zone, the number of web parts allowed in a zone, the certain types of arrangements of the web parts within the zone, or the property configurations allowed for types of web parts within the zones.

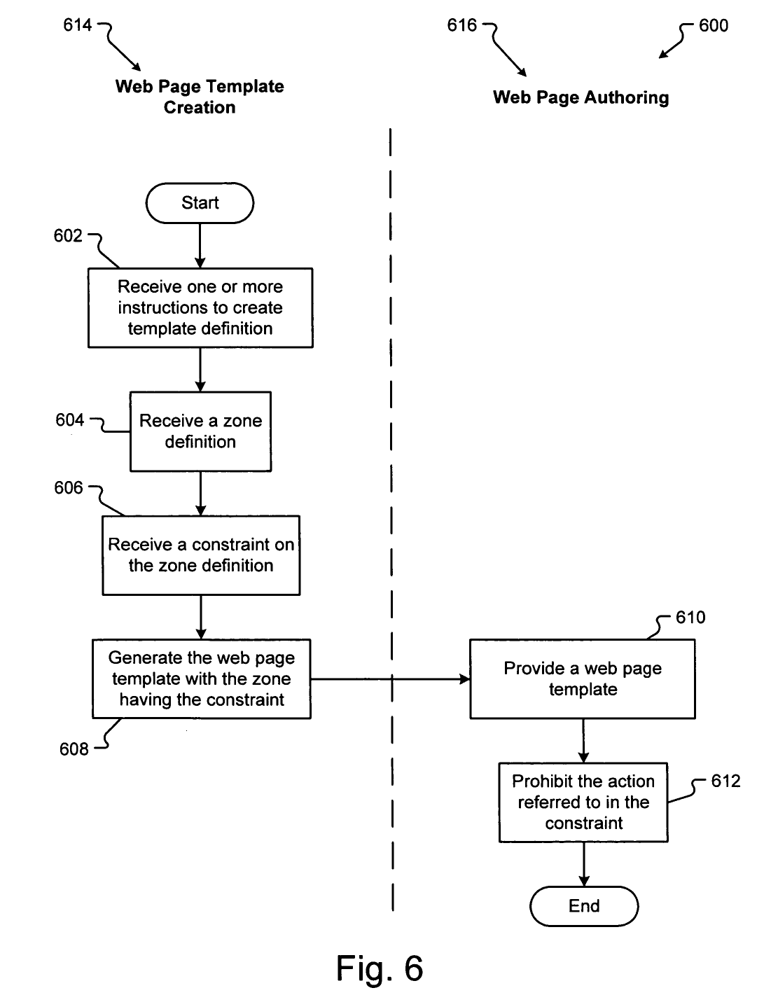

An exemplary embodiment of a web page creation method 600 having a web page template creation phase 614 and a web page authoring phase 616 is shown in FIG. 6. Receive operation 602 receives one or more instructions, such as instructions 504, to create a web page template definition, such as web page template 144. As part of the definitions, receive operation 604 receives a definition, such as definition 506, for a zone, such as zone 152. Also as part of the definitions, receive operation 606 receives a definition, such as definition 510, for a constraint. The constraint limits or prohibits one or more actions in the zone during the web authoring phase. After receiving the definitions, generate operation 608 generates the web part template with one or more zones possibly with each having one or more constraints. Then, provide operation 610 provides a web page template, such as template 402. Finally, prohibit operation 612 prohibits or limits certain actions based on the received constraint.

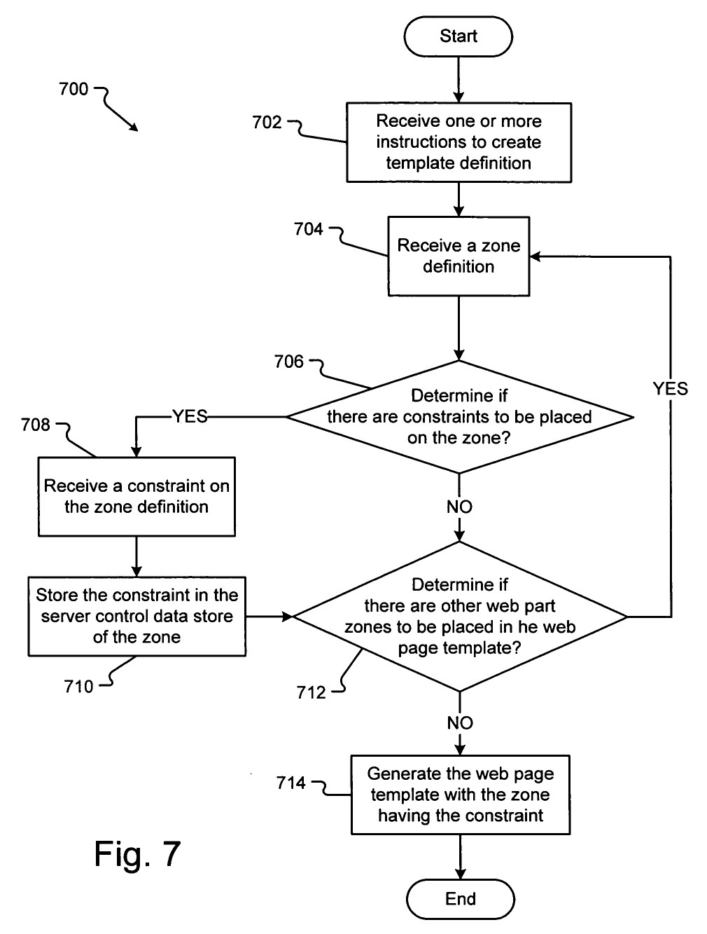

A further exemplary embodiment of a web page template creation process 700 is shown in FIG. 7. Receive operation 702 receives one or more instructions, such as input 318, to create a web page template definition, such as web page template 502. In one embodiment, a web page template developer uses a web page template creation application, such as application 316, to input definitions into a web page template. The definitions input may be saved as a data file that defines the web page template. As part of the definitions, receive operation 704 receives a definition, such as definition 506, for a zone, such as zone 152. In one embodiment, the zone definition is stored in a zone server control data store, such as data store 312. The zone data store becomes a part of the web page template code.

Next, determine operation 706 determines if the zone will have one or more constraints assigned to the zone. In embodiments, the web page template developer selects a UI component in the development application that signals that a constraint is to be assigned to the zone. In other embodiments, the template developer may begin to enter a constraint directly into the web page template code. In still another embodiment, if the template developer begins creating a new zone and does not add a constraint, then the application can determine that no constraint is to be added. If there is a determination that a constraint is to be added, the flow branches YES to receive operation 708. If there is a determination that a constraint is not to be added, the flow branches NO to determine operation 712.

Receive operation 708 receives a definition, such as definition 510, for the constraint. The constraint limits or prohibits one or more actions in the zone during web authoring. One or more constraints may be received. Store operation 710 stores the constraint. In one embodiment, the constraint is stored in a zone server control data store, such as data store 312. A constraint can be applied at web page authoring time after storing the constraint with the web page template.

Determine operation 712 determines if another zone is created. If another zone is created, the flow branches YES to receive operation 704 to receive zone definition and possibly constraints. As such, each zone can have a set of constraints particular to that zone. A web author thus may be able to execute one set of actions in one zone and a different set of actions in another zone. The creation of different constraints in different zones allows the template developer to limit or prohibit discrete actions rather than prohibit or allow editing altogether. After receiving the definitions, generate operation 714 generates the web part template with one or more zones possibly with each having one or more constraints.

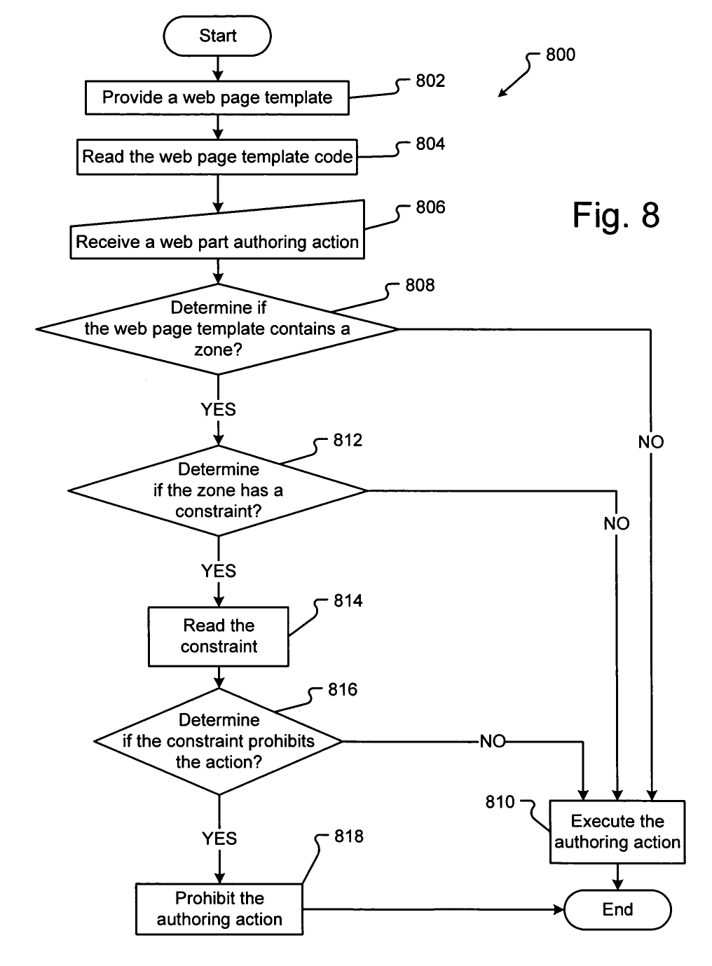

An exemplary embodiment of a web authoring process 800 is shown in FIG. 8. Provide operation 802 provides a web page template, such as template 402. In one embodiment, the web author uses a web authoring application, such as application 422, to retrieve the web page template. The web page template is provided in reaction to the web author action. Read operation 804 then reads the code or definitions, such as definitions 502, in the web page template. Within the definitions, the code describes the configuration of the web page template including any possible zones in the web page template.

Receive operation 806 receives a web part authoring action in the web page template. Any request to access data in the web page is considered a web part authoring action. In one embodiment, the web author changes one or more configurations or content of the web page template. Next, determine operation 808 determines if there are any zones, such as zone 152, in the web page template. If there are no zones, the flow branches NO to execute operation 810. Execute operation 814 then executes the web authoring action. In embodiments, the web authoring application executes software for effectuating the action. If there are zones in the web page template, the flow branches YES to determine operation 812.

Determine operation 812 determines if one or more of the zones has a constraint assigned to the zone. If the zone does not have a constraint, the flow branches NO to execute operation 810. If the zone does have a constraint, the flow branches YES to read operation 814. In one embodiment, any action is possible within the zone because there are no constraints. In another embodiment, no action is allowed because the zone is not editable. In still another embodiment, only a set of actions is allowed according to the constraints.

Read operation 814 reads the constraint(s) for the zone in the web page template. In one embodiment, the web authoring application parses the web page template and identifies each zone having a constraint. The constraints within the zones are identified and read. This constraint information is then sent to the web authoring application. Determine operation 816 determines if the web authoring action is prohibited. In one embodiment, the constraint is compared to the web authoring actions. If the constraint and the web authoring action are the same, the authoring action is prohibited. If the action is prohibited, the flow branches YES to prohibit operation 818. If the action is allowed, the flow branches NO to execute operation 810. Prohibit operation 818 prohibits or limits certain actions based on the constraint. In one embodiment, the action, after being input, is never completed. In another embodiment, the UI presents the web author with a cue that the action was not executed, such as an audible beep or sound. In another embodiment, the UI presents a pop-up window explaining that the action never occurred.

In other embodiments, a remote procedure call (RPC) or other request is sent to a server application, possibly in a remote computer such as computer 280, to execute a web part authoring action on a web page. The server determines if the authoring action is allowed. If the action is not allowed, the remote computer fails to execute the authoring action and returns a notice to the client computer that the authoring action was not completed. The UI at the client computer may display a prompt to the user that the server did not complete the authoring action.

In one embodiment, the UI receives the information regarding the constraints and changes one or more components within the UI to prevent certain web part authoring actions. For example, fewer or a limited set of web parts are provided in the UI to be placed within the zone. In another embodiment, the UI does not provide a selectable component for certain actions (e.g. the UI displays the “◯” symbol). A UI may also provide only a limited set of properties to change for a web part. Thus, rather than receiving a web part authoring action and prohibiting the execution of the action, the UI prevents the web authoring action from being received and eliminates the need to prohibit the execution of the action. One skilled in the art will recognize other processes or methods of constraining authoring actions on a web page, which are included in the present invention.

Although the present invention has been described in language specific to structural features, methodological acts, and computer-readable media containing such acts, it is to be understood that the present invention defined in the appended claims is not necessarily limited to the specific structure, acts, or media described. One skilled in the art will recognize other embodiments or improvements that are within the scope and spirit of the present invention. Therefore, the specific structure, acts, or media are disclosed as exemplary embodiments of implementing the claimed invention. The invention is defined by the appended claims.

What is claimed is:

1. A computer program product encoding a computer program of instructions for executing a computer implemented method for generating a constrained web page template, the method comprising:
receiving one or more definitions to construct a web page template;
receiving a zone definition to place a zone within the web page template;
receiving a constraint assigned to the zone that limits actions within the zone during web authoring; and
generating the constrained web page template having a zone with a constraint.

2. A computer program product defined in claim 1, wherein the constraint is a limitation on one of the type of web part allowed in the zone, the number of web parts allowed in the zone, the number of properties that can be modified on a web part, the configuration of a web part in the zone, or the arrangement of web parts in the zone.

3. A computer program product defined in claim 1, wherein the web page template is constructed with a web page template creation application.

4. A computer program product defined in claim 1, wherein the web page template has a zone server control data store that stores the zone instruction and the constraint.

5. A computer program product defined in claim 1, wherein the zone is a server control.

6. A computer program product defined in claim 1, wherein the zone has two or more constraints assigned.

7. A computer program product encoding a computer program of instructions for executing a computer implemented method for enforcing constraints on a web page template during web authoring, the method comprising:
providing a web page template having a zone, wherein the zone has an assigned constraint; and
prohibiting an action in the zone that would violate the assigned constraint.

8. A computer program product as defined in claim 7, wherein prohibiting comprises:
reading the constraint in the web page template;
sending information regarding the constraint to a user interface component; and
eliminating one or more user interface selections based on the information sent to the user interface.

9. A computer program product as defined in claim 7, wherein prohibiting comprises:
reading the assigned constraint in the web page template;
receiving an action in the zone;
determining if the action is prohibited by the assigned constraint; and
if the action is prohibited, failing to execute the action.

10. A computer program product as defined in claim 7, wherein providing the web page template further comprises providing a zone server control information.

11. A computer program product as defined in claim 7, wherein a web authoring application is operable to allow web authoring of the web page template.

12. A computer program product as defined in claim 7, wherein a web part database stores information about a web part in the web page template.

13. A computer program product as defined in claim 12, wherein one or more web part binary data stores store the binary for one or more web parts in one or more zones.

14. A computer program product as defined in claim 13, wherein one or more of the web part binary data stores are third party data stores with one or more constraints limiting actions directed at one or more web parts in the third party data store.

15. A computer program product as defined in claim 7, wherein the web page template has two or more zones and at least two zones has different constraints.

16. A computer program product as defined in claim 7, further comprising forming a web site from two or more web page templates, wherein at least two web page templates have different constraints on one or more zones within the web page templates.

17. A computer program product encoding a data structure for a constrained web page template, the data structure comprising:
a first data field that contains configuration information for a web page template;
a second data field that contains configuration information for a zone embedded within the web page template; and
a third data field that contains a constraint that prohibits a possible action in the zone during web authoring.

18. A computer program product defined in claim 17, wherein the third data field contains two or more constraints.

19. A computer program product defined in claim 17, wherein there are two or more second data fields and at least two of the second data fields contain constraints that are different.

20. A computer program product defined in claim 17, further comprising a fourth data field that contains configuration information for a web site formed from two or more first data fields, wherein at least two of the first data fields has a different constraint.
